(19) United States
(12) Patent Application Publication
(10) Pub. No.: US 2014/0068853 A1
(43) Pub. Date: Mar. 13, 2014

(54) BATHING FIXTURES

(71) Applicant: Colin Opwald, Caulfield North (AU)

(72) Inventor: Colin Opwald, Caulfield North (AU)

(73) Assignee: MALIFORM PTY. LTD., Caulfield North, Victoria (AU)

(21) Appl. No.: 14/116,861

(22) PCT Filed: May 10, 2012
(86) PCT No.: PCT/AU2012/000507

§ 371 Date: Nov. 11, 2013

(30) Foreign Application Priority Data
May 12, 2011 (AU) 2011901798
Mar. 16, 2012 (AU) 2012901069

(51) Int. Cl. A47K 3/36; E06B 3/50

(52) U.S. Cl. CPC A47K 3/362; E06B 3/5072
USPC 4/607; 49/177

(57) ABSTRACT

A door unit for an enclosure (1), as for example a shower recess or a combined shower/bath, is provided which includes a first panel (20, 301) which is pivotably movable relative to a wall (3) of the enclosure and at least a second panel 21, 302) which is movably and rotatably connected to the first panel (20, 301) at least one of said panels having a roller track associated with an upper end or extremity thereof and the other panel having one or more roller brackets associated with an upper end or extremity thereof, to allow the panels (20, 21 and 301, 302) to be relatively extensibly one to the other, the unit also including means (100) for releasably retaining said panels (20, 21 and 301, 302) in an extended relationship to one another.

### FIELD OF THE INVENTION

The present invention relates, in general terms, to improvements in bathing fixtures. More particularly, but not exclusively, the invention relates to an improved door assembly for use in a bathing fixture such as a shower enclosure, shower recess or the like, such door assembly providing a closure means of adjustable size which does not need support at the uppermost portion thereof, yet still provides a stable, pivotable and slidable arrangement.

### BACKGROUND OF THE INVENTION

Throughout the ensuing specification reference will be made to particular and preferred embodiments of the present invention, a first embodiment which includes opposed pivotable and relatively movable door assemblies each made up of two relatively movable panels, especially suited for use with a shower enclosure or shower recess, and a second embodiment which includes a door assembly which is made up from three relatively movable panels (rather than two). It should be understood, however, that the present invention is not to be considered to be limited to any preferred embodiment or embodiments described and illustrated herein. Indeed the present invention is equally suited to use in, for example, bathing facilities which merely include a bath having a shower rosette associated therewith and disposed thereover, appropriately disposed within a given space.

In the past it has been the practice, with facilities of this general type, to use a shower curtain or curtains, adapted in use to be slidable as desired along a rail, whereby to minimize unwanted egress of water from the bath or shower area when the shower is in use. The arrangements in accordance with the present invention are intended not only to replace the shower curtains used with the prior art arrangements, but at the same time to provide a more stable and more effective closure means for the overall bathing facility.

When designing door assemblies for bathing facilities, whether that facility be a shower enclosure or recess, or a bathtub for that matter, a principal criterion is to facilitate access as much as possible, as well as to provide improved serviceability for as many components as possible in the overall assembly. Ease of access is important in terms of both use and cleaning of the overall facility. It is furthermore extremely desirable for the facility to maximise use of available floor and room space.

U.S. Pat. No. 5,417,272 discloses a wall mounted bathroom panel assembly wherein a slidable panel operates in conjunction with a pivotable panel. This assembly provides the desired ready access. However, the sliding action between the pivotable and sliding panel is effected by rollers and roller tracks mounted in both the pivotable and slidable panels for reciprocal engagement. This arrangement poses problems in that, when the slidable panel is fully extended, an undesired rocking can take place. This arrangement also makes adjustment of the doors or panels relative to one another difficult. Further a multiple bracket and roller structure is required, with brackets and rollers as well as roller tracks provided in both tracks connected to upper and lower portions of each panel.

U.S. Pat. No. 5,908,064 discloses a door unit for a bathing enclosure wherein a pivotable and extendable door unit includes a first panel, which is pivotably connected to a supporting wall of the enclosure, and a second panel which is extendably connected to that first panel. The first panel has a roller bracket at both the upper and lower ends thereof, whilst the second panel has a roller track at both the upper and lower ends thereof. The arrangement is such that the second panel does not have any roller brackets or rollers associated therewith.

A problem associated with door assemblies of this general type is to ensure that they operate smoothly, and continue to so operate. Past experience has revealed that the very weight of the overall door assembly, if not properly distributed during the entire opening and closing procedure, can severely impede such opening and closing and, with time, can perhaps give rise to damage of roller tracks, etc.

Another problem associated with door assemblies of this general type is, or has been, that too few of the components are readily replaceable without necessitating expenditure of a significant amount of time, and hence expense, therein. With the prior art arrangements damage to many components, no matter how sustained, could not be readily repaired, nor could the majority of components be readily replaced.

It is an object of the invention to provide a pivotable and extendable door unit for a bathing facility which can provide a stable, slidable operation of the extendable door.

It is another object of the invention to provide a door unit for a bathing facility which can be produced with fewer parts and at low cost.

It is another object of the invention to provide an extendable door unit for a bathing facility wherein the means for providing the extendibility of the panels which make up the overall door can be easily adjusted.

It is yet a further object of the invention to provide an arrangement wherein, apart from the glass panels or panes, all other components can be readily removed for repair or replacement. The aim of the exercise is to provide a door unit which, if it sustains damage other than to the glass panels, can be repaired without need for replacement of the overall door.

It is another object of the invention to provide an extendable door unit for a bathing facility which is adaptable to be suitable for use with various shapes and sizes of bathing facilities.

It is yet a further object of the invention to provide an extendable door unit for a bathing facility which can be employed individually or in combination with another door of the same type.

Another object of the invention is to provide a means for releasably closing a door assembly, whilst at the same time protecting against the possibility of an unlocked door swinging freely away from the enclosure. The door assembly in accord with the invention, even when closed, can be moved along its track which is associated with the shower base or bath, but cannot swing freely even if opened. This is important in terms of improved safety.

In accordance with a preferred embodiment or aspect of the invention there is provided a door unit for an enclosure, said door unit including: a first panel which is adapted to be pivotably movable relative to a wall of said enclosure and a second panel which is adapted to be movably connected to said first panel and to be extensibly connected to said first panel, wherein one of said first and second panels has a roller track associated with an upper end or extremity thereof and the other of said panels has one or more roller brackets associated with an upper end or extremity thereof, the arrangement being such as to allow said panels to be relatively extensible one to the other, and further including means for releasably retaining said panels in an extended relationship to one another

In accordance with another embodiment or aspect of the invention there is provided a door unit or assembly for an enclosure, said door unit including: a first panel which is adapted to be pivotably movable relative to a wall of said enclosure; a second panel which is adapted to be movably and extensibly connected to said first panel; and a third panel which is pivotably connectable to said second panel, wherein at least one of said panels has a roller track associated with the upper end or extremity thereof and the or each other of said panels has one or more roller brackets associated with the upper end or extremity thereof, the arrangement being such as to allow said panels to be relatively extensible one to the other, and further including means for releasably retaining said panels in an extended relationship to one another.

### DESCRIPTION OF THE DRAWINGS

In order that the invention may be more clearly understood and put into practical effect there shall now be described in detail preferred constructions of a door unit in accordance with the invention. The ensuing description is given by way of non-limitative example only and is with reference to the accompanying drawings, wherein:

FIG. 1 is a top perspective view showing two door units or assemblies in accordance with the present invention as located within a bathing facility, in this instance a shower enclosure;

FIG. 2 is a front view of the embodiment of FIG. 1;

FIG. 3 is a top view of the embodiment of FIG. 1;

FIG. 4 is an exploded perspective view of a door unit or assembly in accordance with the present invention;

FIG. 5 is an exploded view, from the rear, of a locking assembly in accordance with the invention; and

FIG. 6 is an exploded view, from the front, of the locking assembly of FIG. 8;

FIG. 7 is a front view of an alternative embodiment of the present invention, involving a single door assembly associated with a bath-tub, with the door assembly in its expanded position;

FIG. 8 is a side view of the embodiment of FIG. 7, with the door assembly in its retracted position;

FIG. 9 is a perspective view of the embodiment of FIG. 7;

FIG. 10 is a partial perspective view of a preferred embodiment of the invention;

FIG. 11 is an enlarged view of a locking mechanism in accordance with the present invention, in use with a preferred embodiment of a door assembly;

FIG. 12 is a sectional view taken through a locking mechanism in accordance with the present invention;

FIG. 13 is a top perspective view of a further embodiment of the invention;

FIG. 14 is a view, similar to FIG. 13 showing the door assembly in accordance with the invention partially expanded;

FIG. 15 is a view, similar to FIG. 13, showing the door assembly in its fully expanded condition;

FIG. 16 is a view, similar to FIG. 15, showing the third panel in a partially extended condition;

FIG. 17 is a view, similar to FIG. 13, showing the locking mechanism in its open or un-locked condition;

FIG. 18 is an exploded view of the locking mechanism in FIG. 13;

FIG. 19 is an exploded view of the locking mechanism of FIG. 17;

FIG. 20 is a view of the embodiment of FIGS. 13 to 19 in its retracted, non-use condition; and

FIG. 21 is a view similar to FIG. 20, showing the door assembly in its retracted condition and swing outwardly of the mechanism.

### DESCRIPTION OF THE PREFERRED EMBODIMENTS

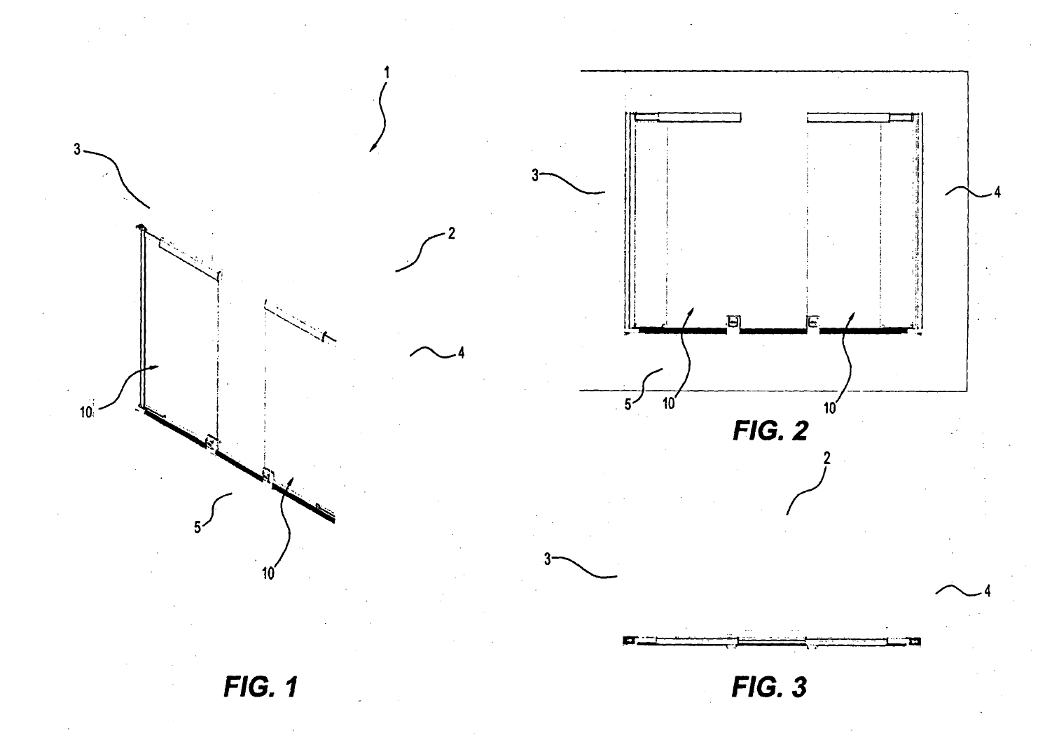

With reference firstly to FIG. 1, there is shown therein an especially preferred embodiment of the present invention, as installed in relation to a bathing/showering facility or enclosure which is generally designated 1, which enclosure 1 is made up of a rear wall 2, respective side walls 3 and 4 and a tub, showerbase or the like 5. To close off the overall enclosure 1 when in use, and prevent unwanted egress of water therefrom, as by splashing, a plurality of door assemblies 10 are provided, adapted to extend across the opening of the overall enclosure 1. Each door assembly 10 is made up from two interconnecting panels, in use extensible relative one to the other in a manner to be described hereinafter in more detail.

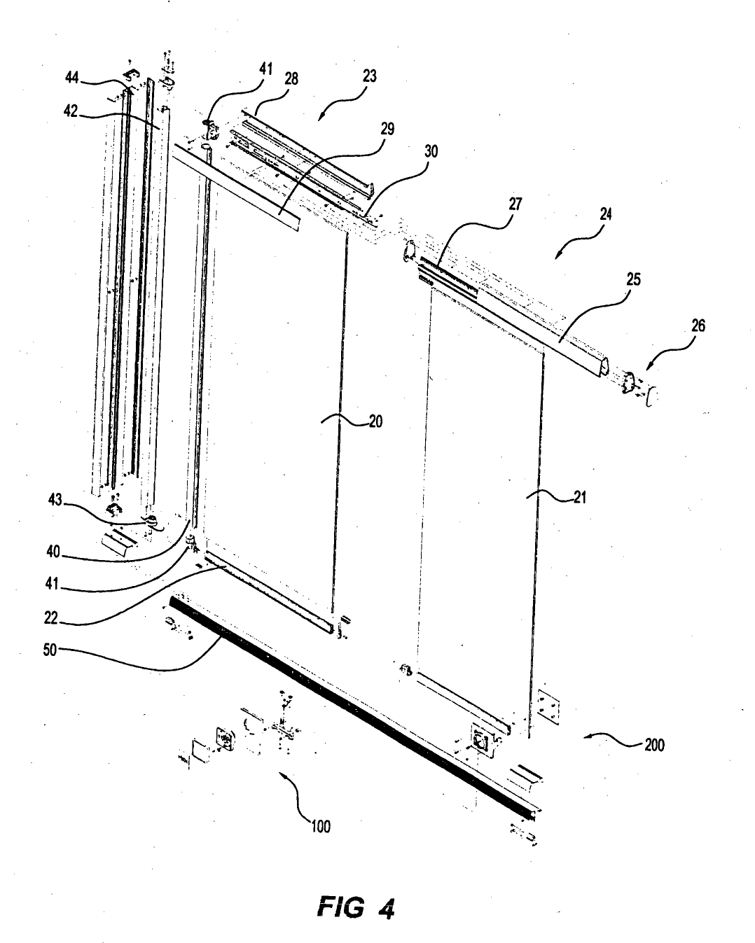

Turning then to FIG. 4 a door assembly 10, represented as in FIGS. 1 to 3, is comprised of two panels 20 and 21, with panel 21 being adapted to be slidably movable relative to panel 20, and panel 20 in itself being pivotably movable relative to a side wall 3 (or 4) of said enclosure 1.

Each of the panels 20 and 21 preferably is made up from a sheet or panel of glass or other suitable material with a frame member 22 of any suitable material, as for example a metal or a plastics material, being associated with the lower end thereof and being affixed thereto in any known manner and using any known means, as for example screws. Each of the panels 20 and 21 also has associated with the upper end thereof frame assemblies 23 and 24 respectively. The frame assembly 24, for example, is comprised of a channel member 25, end cap assembly 26 and a track 27 which is adapted, in use, to be disposed within the channel member 25. The frame assembly 23, on the other hand, is comprised of channel member 28, capping member 29 and track 30 adapted, in use, to be interposed therebetween.

The panel 20 is adapted in use to be associated with, in any known manner and using any known means, a pivot column 40 which extends substantially along the height dimension of that panel 20. The pivot column 40 has located at and co-operates with, at each end thereof, a pivot block or bushing 41. Preferably each pivot block or bushing 41 will be releasably connected to the pivot column 40 by means of a screw or the like means, but the actual means of connection is not of the essence of the invention. In turn the pivot column 40 is adapted to be attached to a jamb member 42, having disposed at each end thereof a pivot block 43. That jamb member 42 is, in its turn, attached to a wall jamb 44 by any suitable means and in any known manner, as for example by screws. That wall jamb 44 is affixed to a wall of the enclosure, as for example a side wall 3 thereof.

In accordance with known practices one or more roller brackets (not shown) will be attached at or in the vicinity of at least one of the panels 20, 21, with a plurality of rollers or the like being rotatably mounted on the or each bracket by means of an arm member, with the rollers being adapted to ride in the track of the other panel. The end cap assembly 26 may engage the or each roller bracket

Extending across at least part of the opening of the enclosure, and releasably affixed to the showerbase 5, is a rail 50.

In accordance with a preferred feature of the invention there is provided a means for retaining a door assembly (or assemblies) in place relative to the rail 50 whereby to limit movement of the door assembly to along that rail 50, with the rail 50 acting as a guide, and to prevent the door assembly from swinging outwardly away from the rail 50 and the overall enclosure. With the prior art arrangements it would be possible for a door or closure means to swivel, swing or pivot out of and away from the enclosure, with consequences of possible damage to the door assembly itself. In accordance with the present invention a door assembly cannot be unlocked from the guide rail 50, thereby avoiding the possibility of unwanted swinging or pivoting thereof. The arrangement should be such that the locking mechanism itself can be actuated either internally or externally of the bathing facility or enclosure 1.

In accordance with a preferred embodiment of the invention there is provided a manually operable means for releasably fixing or locking a door assembly 10 in place relative to the track or rail member 50. In the especially preferred embodiment illustrated the locking means takes the form of a releasable fastening means, adapted to be mounted on and to be selectively and progressively movable relative to the rail member 50.

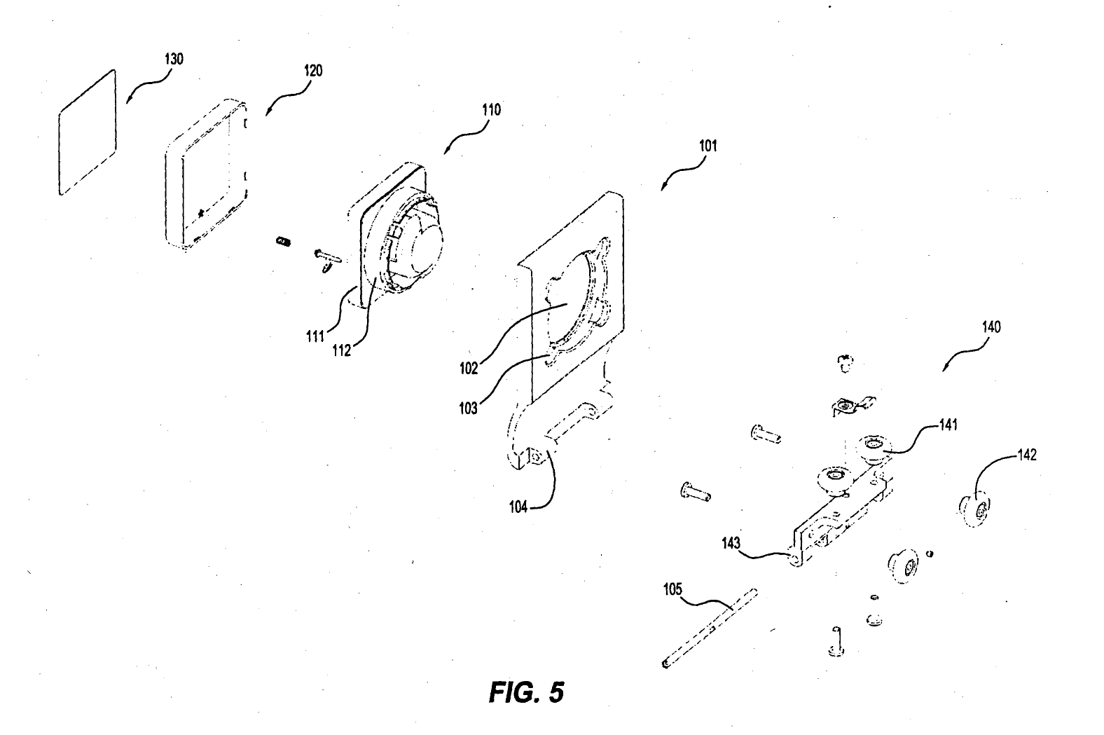

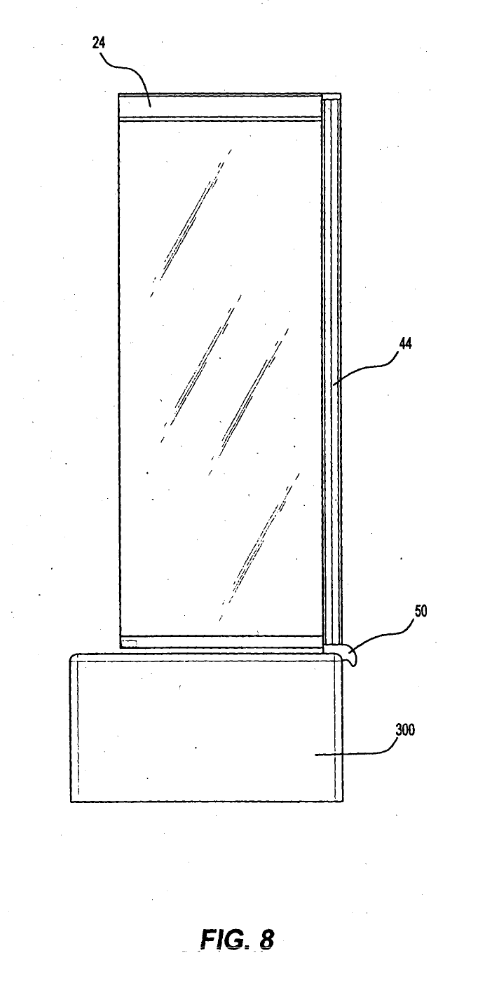

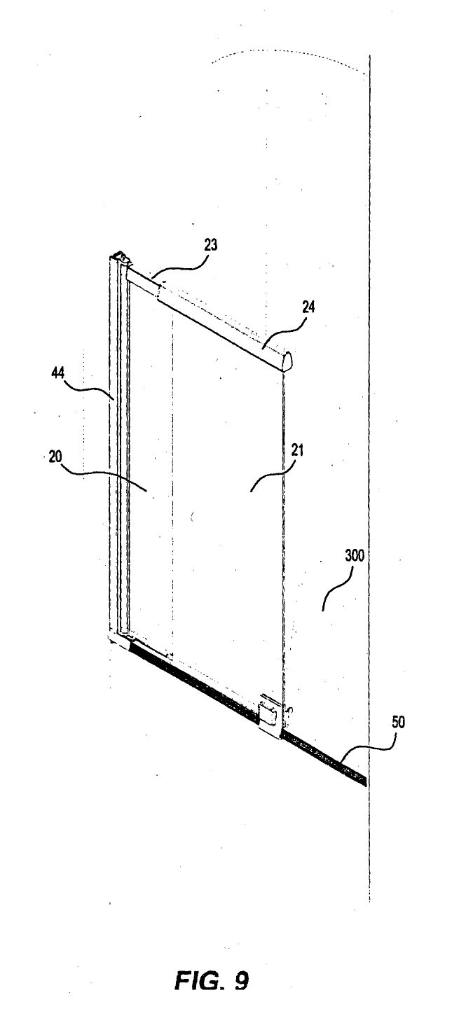

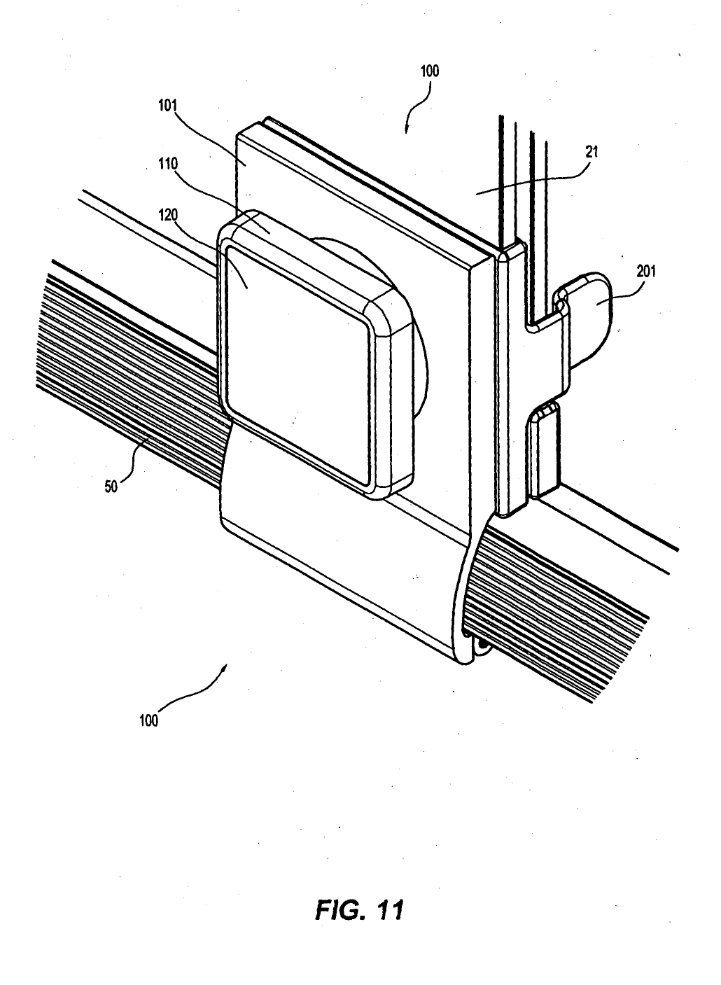

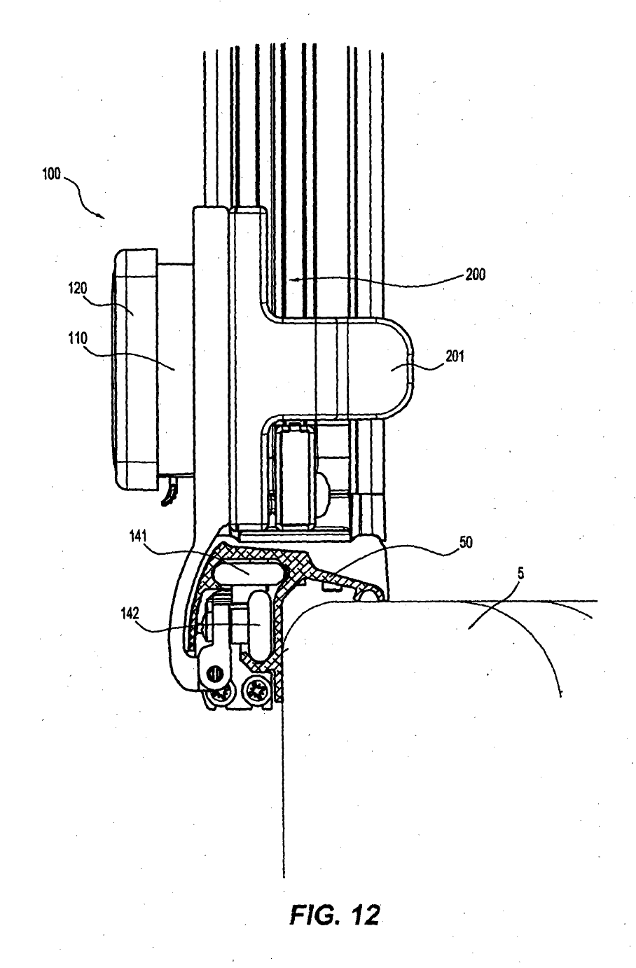

Such a locking mechanism, as shown in FIGS. 5 to 12, includes two principal components, a first assembly 100 which is adapted to be disposed externally of the enclosure 1 and is further adapted to co-operate with the rail 50 (in a manner to be explained in more detail later) and a second assembly 200 which is adapted to be releasably attachable to a door or panel, as for example 21, of the door assembly.

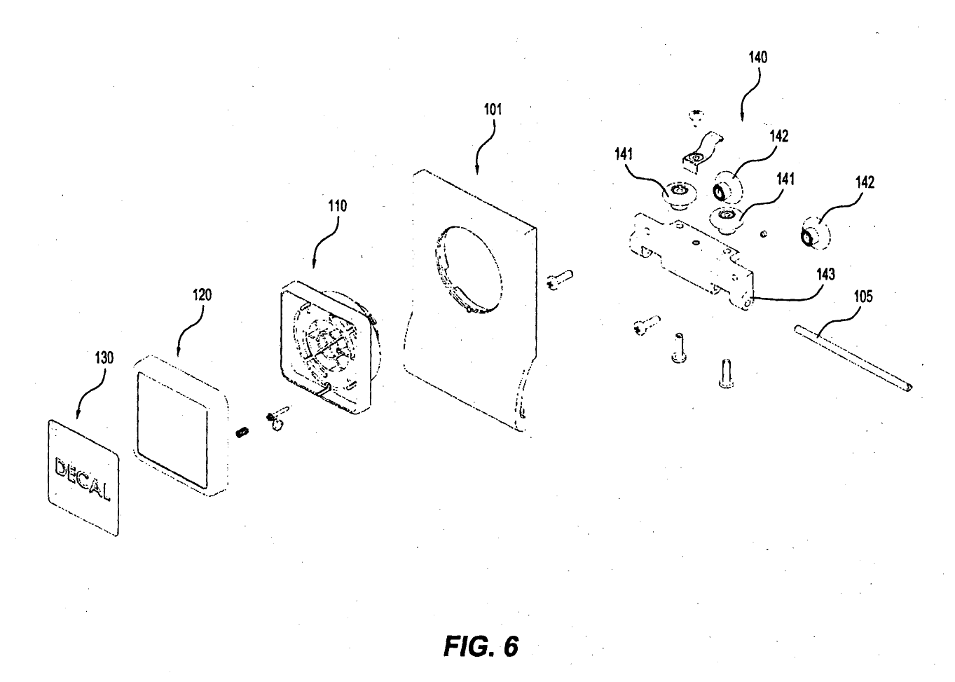

An especially preferred embodiment for a locking mechanism first assembly 100 is shown, in exploded views, in FIGS. 5 and 6. Such includes, as its principal components, a pivotable arm member 101, co-operating locking member 110, fascia member 120, a decal or the like 130 to be associated with the fascia member 120, and a roller track assembly generally designated 140.

The arm member 101, constructed of any suitable material, may take the form of a substantially oblong member having a circular aperture 102 extending therethrough in the vicinity of one end thereof. That aperture 102 preferably includes four indents or notches 103 disposed at substantially 90° intervals around the circumference thereof. At the other end of the oblong member there are provided means which allow for pivoting of said arm member 101, as and when desired, between respective open and closed positions for the overall locking means. Whilst the means which allow for pivoting are not of the essence of the invention, in the preferred embodiment illustrated such are in the form of a plurality of knuckles 104 disposed at spaced-apart intervals at or in the vicinity of the lower portion of the arm member 101. The roller track assembly 140 includes pairs of rollers 141, 142 disposed at right angles one to the other, and a plurality of knuckles 143 which are adapted to co-operate, with the interposition of a pivot pin 105, with the complementary knuckles 104 of the arm member 101.

The locking member 110, in the preferred embodiment illustrated, is in the form of an oblong member having a base portion 111 and a substantially circular cylindrical projection 112 extending substantially normally thereto. At the free end of that projection 112 there is provided a cam-like structure 113.

The locking means further includes a second member 200 which is adapted to be releasably attached to the external surface of a door panel, as for example by screws. That second member 200 includes, projecting from the base thereof, a substantially circular formation of a complementary shape to the aperture 102 of arm member 101. The member 200 further includes, extending laterally thereof, a latch or projection 201 which, in use, projects into the enclosure 1 whereby to allow for release of the locking mechanism internally of said enclosure 1.

In an alternative embodiment, not shown, a locking means in accordance with the invention may take the form of a magnetic coupling or other form of releasable locking means, adapted also to be mounted on and selectively and progressively movable relative to the track 50.

In yet a further alternative, also not shown, opening and closing of the door may be achieved in an automated manner. With such an embodiment the door will have associated therewith an automated means, such as for example a low-voltage motor, having a drive cam in operable connection therewith. A switch or button for activating such motor may be disposed internally of the enclosure 1, for operation by the user as and when required. By way of example in use the user, upon entering the enclosure 1, will push the switch or button to thereby move the door(s) to the closed position. When bathing is finished, pushing the switch or button will then open the door(s) to allow egress from the enclosure 1.

It should be understood, however, that the locking means is not to be limited to any preferred embodiment described and/or illustrated in the specification. Indeed any means may be utilised to interconnect a door assembly to the track 50 so that it is held rigidly in place whilst allowing the door to function normally to allow access to the enclosure 1, whether for purposes of use or cleaning.

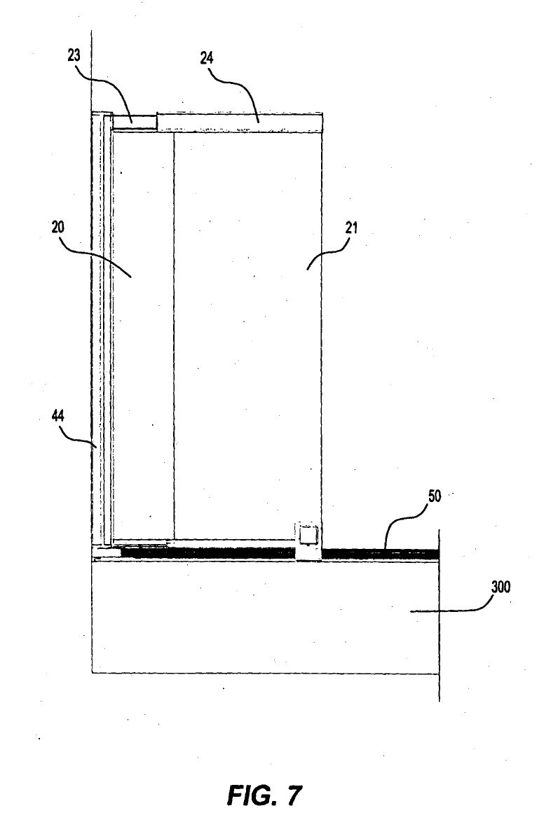

FIGS. 7 to 9 show a door assembly in accordance with the invention is use with a bathtub 300. That bathtub 300 has a rail or track 50 attached to and extending along the top dimension thereof. That rail 50 has a locking assembly in accordance with the invention, as previously described herein, releasably attachable thereto and selectively movable therealong.

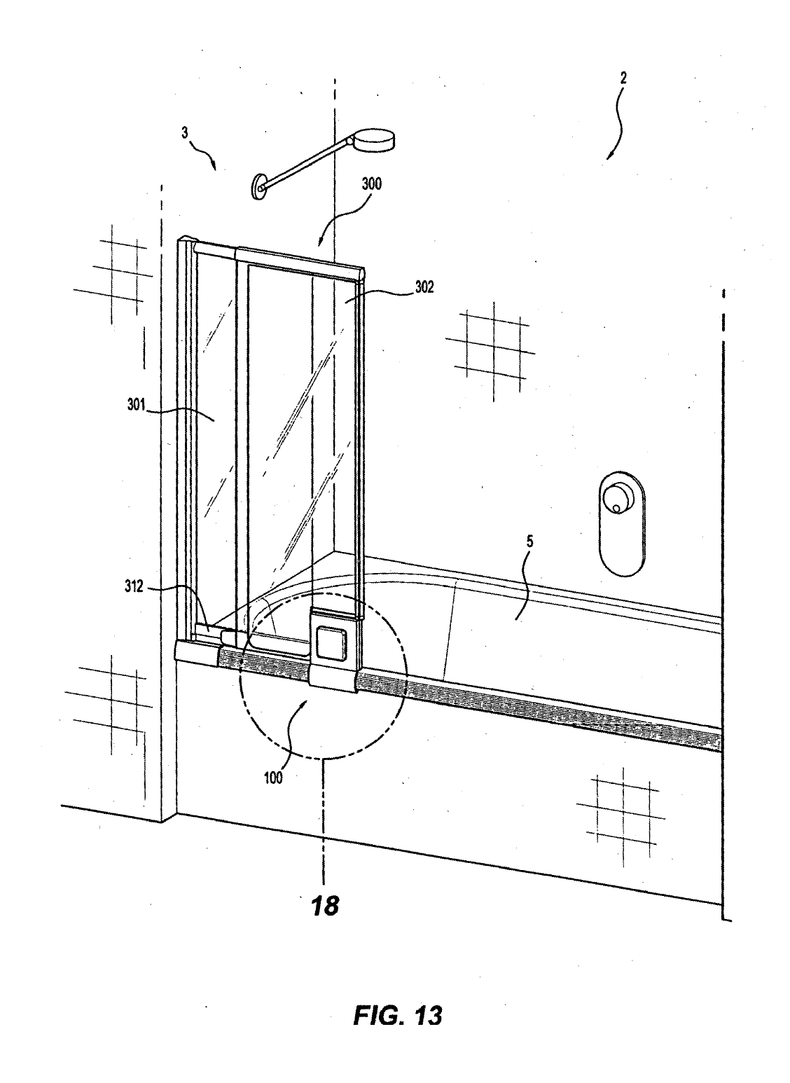

Turning now to FIGS. 13 to 21, there is illustrated therein an alternative embodiment of the invention, involving a door or closure assembly for a shower enclosure or the like which is made up from three (3) inter-connected and relatively movable panel sections. This embodiment is now explained in more detail, using a similar numbering system (for the various components) to that used with the embodiments of FIGS. 1 to 12.

FIGS. 13 to 21, as with FIGS. 1 to 12, show an alternative embodiment of the present invention, as installed in relation to a bathing/showering facility or enclosure generally designated 1, which enclosure 1 is made up of a rear wall 2, respective side walls 3 and 4 and a tub, showerbase or the like 5. To close off the overall enclosure 1 when in use, and prevent unwanted egress of water therefrom, as by splashing, at least one door assembly 300 is provided, extending at least partially across the opening of the overall enclosure 1. The or each door assembly 300 is made up from three interconnecting panels 301, 302 and 303, in use extensible relative one to the other in a manner to be described hereinafter in more detail.

Each of the panels 301, 302 and 303 is made up principally of a sheet or panel of glass or other suitable material, with a frame member 312 of any suitable material, as for example a metal or a plastics material, being associated with the lower end of each of panels 301 and 302 and affixed thereto in any known manner and using any known means, as for example screws. Each of the panels 301 and 302 also has associated with the upper end thereof frame assemblies 313 and 314 respectively. The frame assembly 314, for example, and in like manner to the embodiment of FIGS. 1 to 12, is comprised of a channel member, end cap assembly and a track adapted, in use, to be disposed within the channel member. The frame assembly 313, on the other hand and again in like manner to the embodiment of FIGS. 1 to 12, is comprised of channel a member, capping member and track adapted, in use, to be interposed therebetween.

In accordance with known practices one or more roller brackets (not shown) will be attached at or in the vicinity of at least one of the panels 301, 302, with a plurality of rollers or the like being rotatably mounted on the or each bracket by means of an arm member, with the rollers being adapted to ride in the track of the other panel. The end cap assembly 26 may engage the or each roller bracket

The panel 301 is adapted, in use, to be associated with, in any known manner and using any known means, a pivot column which extends substantially along the height dimension of that panel 301. The pivot column, in like manner to the embodiment of FIGS. 1 to 12, will have located at and co-operates with, at each end thereof, a pivot block or bushing. Preferably each pivot block or bushing will be releasably connected to the pivot column by means of a screw or the like means, but the actual means of connection is not of the essence of the invention. In turn the pivot column is adapted to be attached to a jamb member having disposed at least end thereof a pivot block. That jamb member is, in its turn, attached to a wall jamb by any suitable means and in any known manner, as for example by screws. That wall jamb is affixed to a wall of the enclosure 1, as for example a side wall thereof.

Again in like manner to the embodiment of FIGS. 1 to 12, extending across the opening of the enclosure, and releasably affixed to the showerbase, is a rail 350.

In accordance with the invention, and in like manner to the embodiment of FIGS. 1 to 12, there is provided in the embodiment of FIGS. 13 to 21 a means for retaining the door assembly 300 in place relative to the rail 350 whereby to limit movement of the door assembly 300 to along that rail 350, with the rail 350 acting as a guide, and to prevent the door assembly 300 from swinging outwardly away from the rail 350 and the overall enclosure. In accordance with the present invention a door assembly cannot be unlocked from the guide rail 350, thereby avoiding the possibility of unwanted swinging or pivoting thereof.

In accordance with the invention, with the embodiments of FIGS. 1 to 13 and in like manner with the embodiment of FIGS. 1 to 12, there is provided a manually operable means for releasably fixing or locking a door assembly 300 in place relative to the track or rail member 350. In the especially preferred embodiment illustrated the locking means takes the form of a releasable fastening means, adapted to be mounted on and to be selectively and progressively movable relative to the rail member 350.

Such a locking mechanism, as shown in the drawings and as in the embodiment of FIGS. 1 to 12, includes two principal components, a first assembly 100 which is adapted to be disposed externally of the enclosure 1 and is adapted to co-operate with the rail 35, and a second assembly 200 which is adapted to be releasably attachable to a door or panel, as for example 302, of the door assembly 300.

An especially preferred embodiment for a locking mechanism is shown, in exploded views, in FIGS. 5 and 6 for example, as described earlier in this specification in more detail.

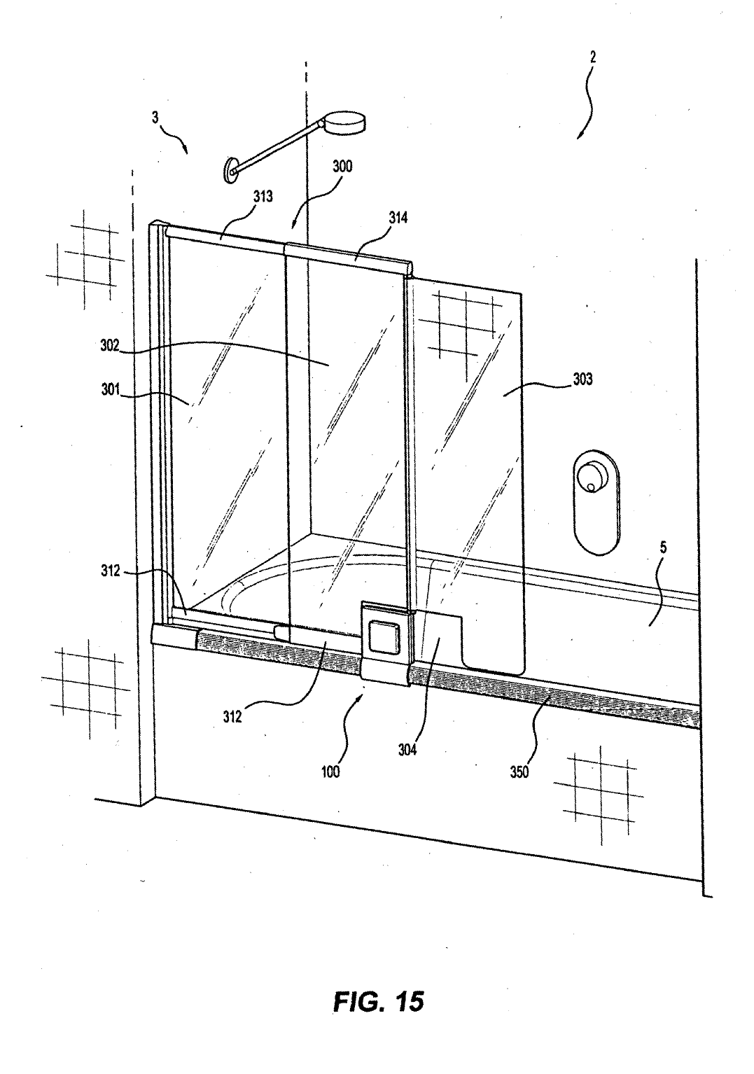

In the preferred embodiments best illustrated, for example, in FIG. 15, the panel 303 includes a cut-out or cut-away 304, of a size and shape complementary to that of the second member 200 of the locking means. Such facilitates rotation/folding of that panel 303 relative to panel 302.

As with the embodiment of FIGS. 1 to 12, with the embodiment of FIGS. 13 to 21 opening and closing of the door assembly 300 may be achieved in an automated manner. With such an arrangement the door will have associated therewith an automated means, as for example a low-voltage motor, having a drive cam in operable connection therewith. A switch or button for activating such motor may be disposed internally of the enclosure, for operation by the user as and when required. By way of example the user, upon entering the enclosure, will push the switch or button to thereby move the door(s) to the closed position. When bathing is finished, pushing the switch or button will then open the door(s) to allow egress from the enclosure.

It should be understood that the locking means for this alternative embodiment of FIGS. 13 to 21 is not to be limited to any preferred embodiment described and/or illustrated in the specification. Indeed any means may be utilised to interconnect a door assembly to the track 350 so that it is held rigidly in place whilst allowing the door to function normally to allow access to the enclosure, whether for purposes of use or cleaning.

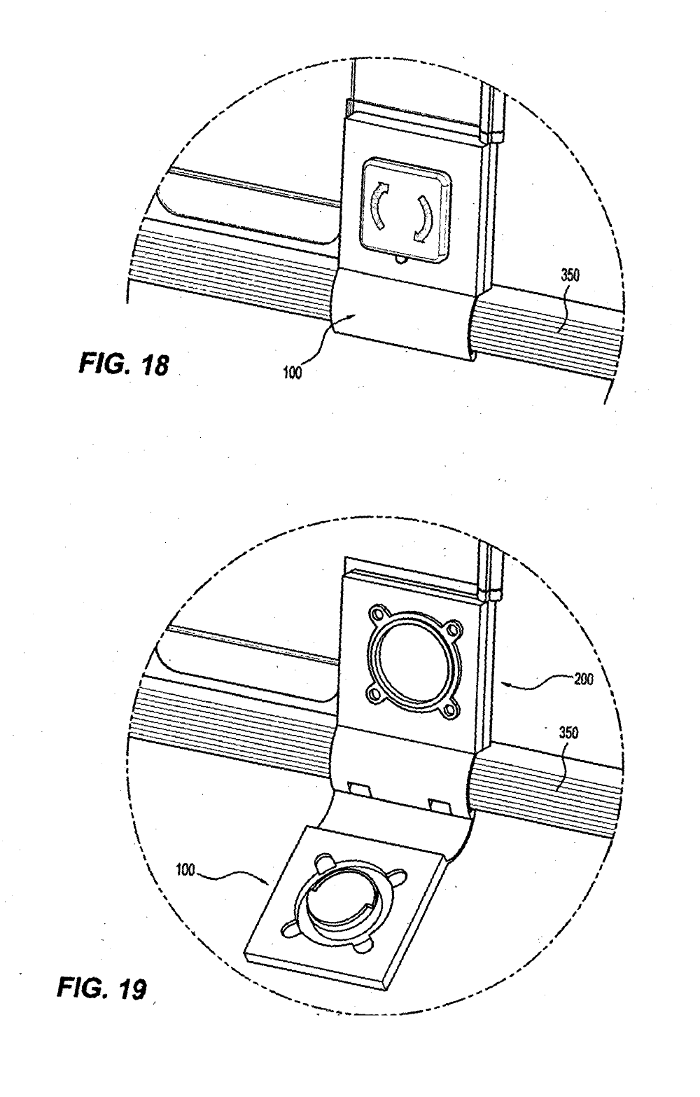

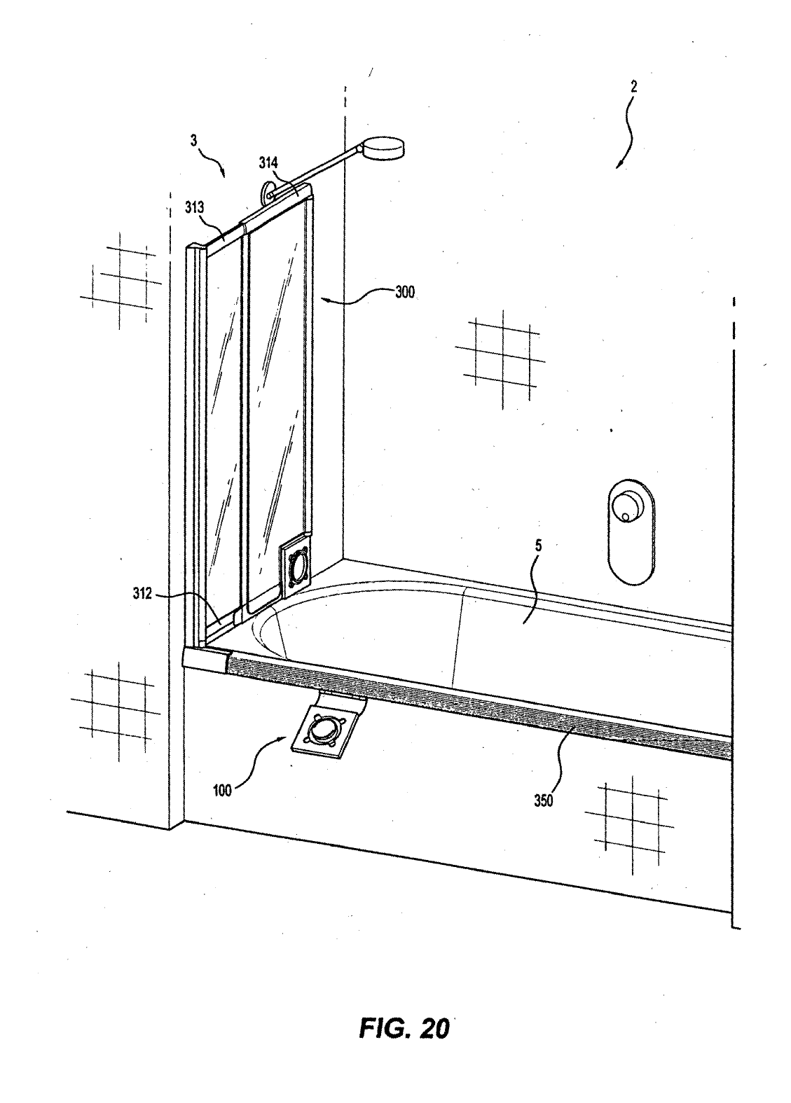

With particular reference to FIGS. 18 and 19, there is shown therein the locking mechanism in respective closed and open positions. When in the open position the locking mechanism first assembly 100 is moved pivotably out of connection/association with the second assembly 200, in turn allow for movement of the relevant panel (3) relative to the rail 350. As shown in FIG. 20 the first assembly 100 may be releasably and removably associated with the rail 350. It should be noted that the same applies to the embodiment of FIGS. 1 to 12, with the first assembly 100 thereof being releasably and movable associated with the rail 50.

The arrangement in accordance with the present invention differs from the prior art, as represented for example by the aforementioned U.S. Pat. No. 5,908,004, in that there is no roller track and/or roller bracket provided at the bottom or lower end of the panels.

A door assembly in accordance with the present invention is not prone to the problems experienced with the prior art, associated with incorrect distribution of the overall weight thereof when in operation, which in turn give rise to inefficient operation (as by opening and closing) of the door(s) and, with time, damage as by bending to roller tracks and the like components, ultimately leading to the door(s) becoming non-usable and needing to be replaced. Such replacement was a labour-intensive, time-consuming and accordingly expensive exercise.

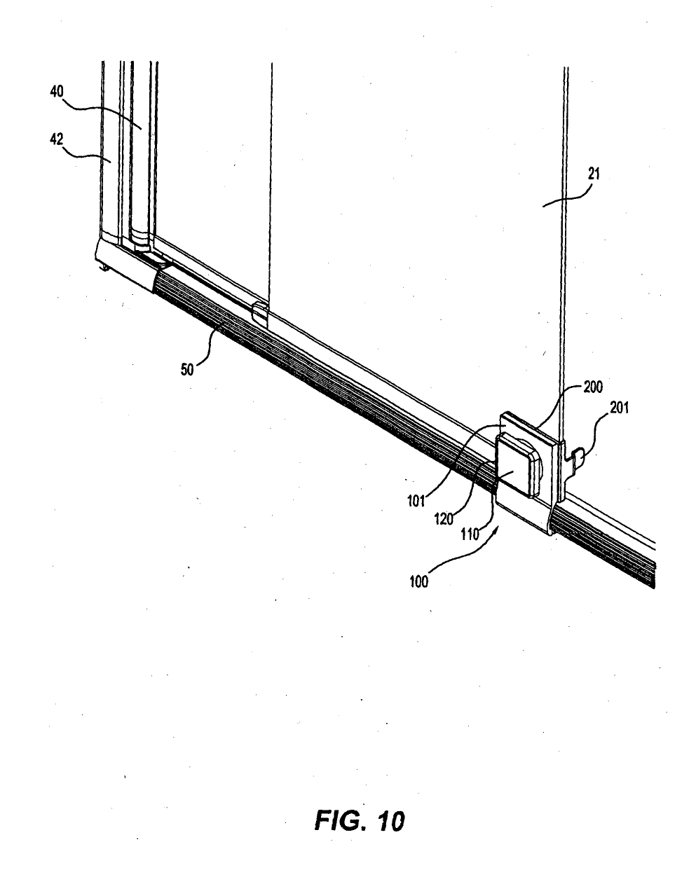

A problem associated with prior art door or closure assemblies of the general type is that, with a multi-panel configuration, there may exist an uneven gap between the panels. One means of avoiding this, or protecting against the possibility of such an uneven gap, would be to include a “built-in” adjustment means. In a preferred embodiment, not shown, the latch or projection 201 as shown for example in the embodiment of FIG. 10 could include a cam or the like means or mechanism to allow for a degree of adjustment of adjacent/interconnected panels.

It should be understood that door assemblies in accordance with the invention can be installed relative to an enclosure and in particular an enclosure including a bath-tub or the like, either indirectly or directly associated with the bath-tub 5 or overall enclosure 1. Indeed a door assembly could be to a bath-tub substantially fixedly attached by any suitable means or method, as for example by screwing into place relative thereto or, in the alternative, it could be less permanently associated therewith.

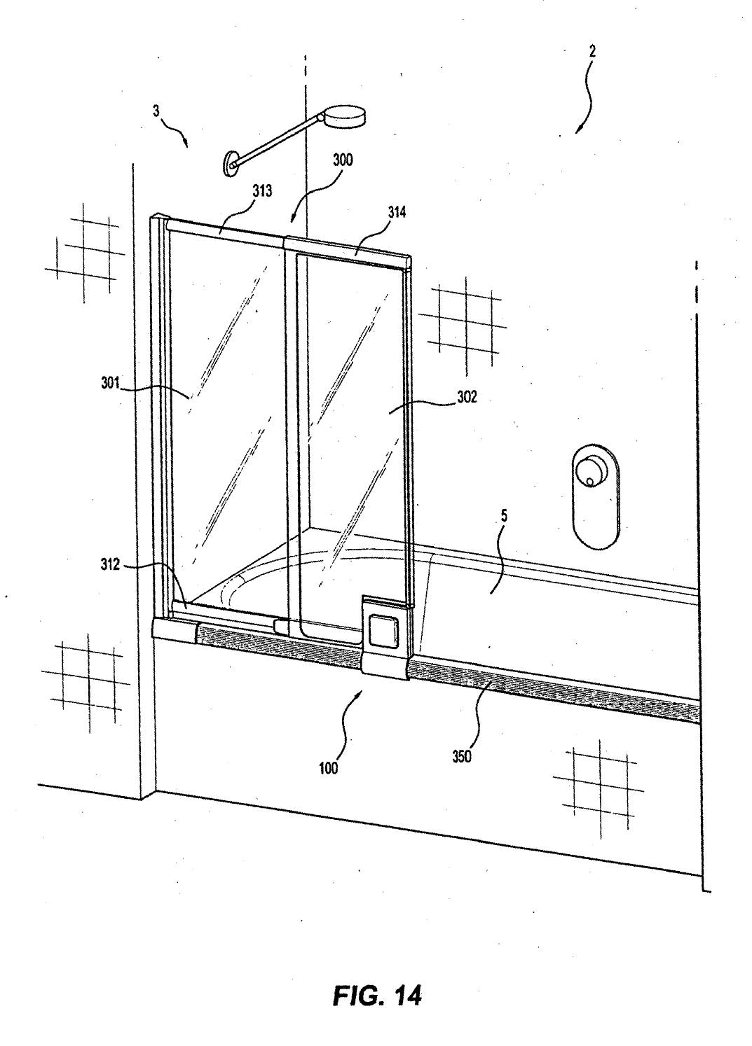

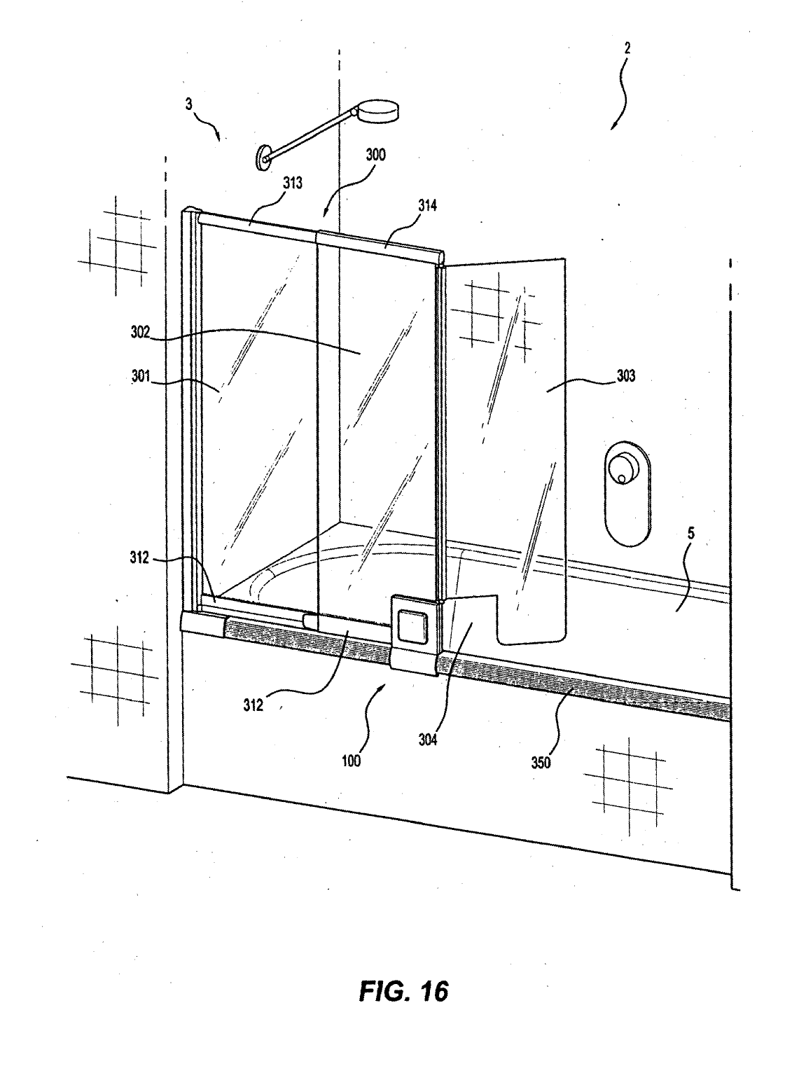

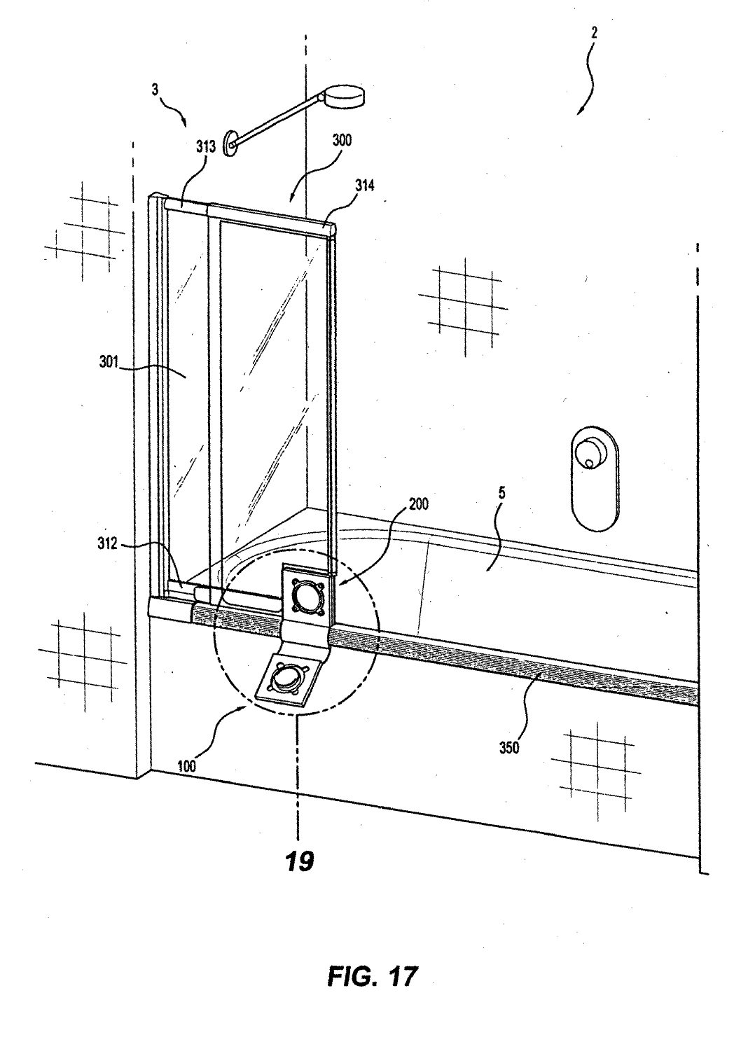

As clearly shown in the drawings, in both embodiments of the invention illustrated the door unit in accordance with the invention is adapted to be, is capable of being, continuously and selectively movable relative to the overall enclosures. In FIG. 13, for example, the door unit is shown extending only a short distance along the width dimension of the enclosure, with the second panel only extending partly beyond the first panel and the third panel being disposed adjacent the second panel. In FIG. 14 the door unit has been extended further across the enclosure itself. In FIG. 15 the door unit is shown in its fully extended configuration, with the locking means actuated to prevent unwanted separation from the rail and pivotable movement away from the enclosures. In FIG. 16 the third panel is capable of being pivotably moved relative to the second panel (locked in position relative to the rail). In FIG. 17 the locking mechanism is shown disengaged, whereby to release the door unit from the rail and allow for pivoting thereof. FIG. 20 shows the door unit in its fully retracted configuration, pivoted inwardly relative to the side wall of the disclosure. This is the most appropriate/effective not-in-use configuration, with the door unit in no way affecting access to the interior of the enclosure. Such is especially significant when the enclosure is, as shown, a combined bath/shower arrangement.

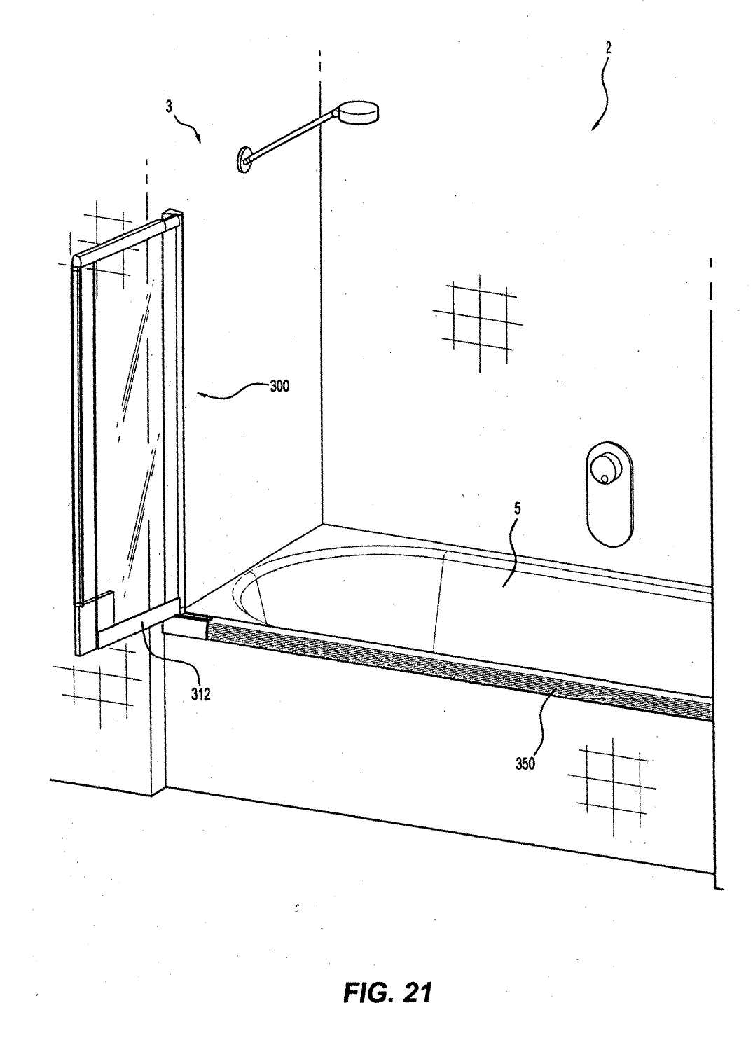

FIG. 21, on the other hand, shows the door unit in its fully retracted configuration but pivoted outwardly of the enclosure. Such allows ready access to the enclosure, whether for use or for purposes of cleaning.

Finally, it is to be understood that the aforegoing description refers merely to preferred embodiments of the invention, and that variations and modifications will be possible thereto without departing from the spirit and scope of the invention.

1. A door unit for an enclosure, said door unit including:
a first panel which is adapted to be pivotably movable relative to a wall of said enclosure and a second panel which is adapted to be movably connected to said first panel and to be extensibly connected to said first panel, wherein one of said first and second panels has a roller track associated with an upper end or extremity thereof and the other of said panels has one or more roller brackets associated with an upper end or extremity thereof, the arrangement being such as to allow said panels to be relatively extensible one to the other, and further including means for releasably retaining said panels in an extended relationship to one another

2. The door unit as claimed in claim 1, wherein said enclosure is a bathing facility including a bath or tub, wherein said bath or tub includes a rail disposed at the top thereof and extending along the length dimension of the front edge thereof.

3. The door unit as claimed in claim 2, wherein the or each roller bracket includes an adjustment means for positioning rollers relative to said roller track.

4. The door unit as claimed in claim 3, further including roller stop members connected to said second panel to thereby limit extension of said second panel relative to said first panel.

5. The door unit as claimed in claim 4, wherein each panel has associated with the respective top and bottom ends or extremities thereof a frame assembly, comprised of an elongate channel member, an end cap assembly and a track which is adapted, in use, to be disposed within said channel member.

6. The door unit as claimed in claim 5, wherein said first panel is adapted, in use, to be pivotably associated with a pivot column assembly which extends substantially along at least a part of the height dimension of said enclosure, said pivot column assembly comprised of a pivot column and a pivot block or bushing at each end of said pivot column, said pivot column assembly being adapted in use to be affixed to a side wall of said enclosure, with or without the interposition of a jamb member.

7. The door unit as claimed in claim 6, wherein said enclosure includes a rail member extending thereacross and releasably affixed thereto.

8. The door unit as claimed in claim 7, including means for releasably retaining said unit in place relative to said rail, thereby to restrict movement of said door unit away from said rail, said retaining means adapted to be activated either internally or externally of said enclosure.

9. The door unit as claimed in claim 8, wherein said retaining means comprises a releasable fastening means which is adapted to be mounted on and to be selectively and progressively movable relative to, the said rail.

10. The door unit as claimed in claim 9, wherein said fastening means includes: a first assembly which is adapted to be disposed externally of said enclosure and which is adapted to co-operate with the rail; and a second assembly which is adapted to be releasably adapted to a second of said panels.

11. The door unit as claimed in claim 10, wherein said first assembly includes a pivotable arm member, a co-operating locking member and a roller track.

12. The door unit as claimed in claim 11, wherein said arm member includes a substantially oblong member having a substantially circular aperture extending therethrough in the vicinity of one end thereof, said aperture including indents or notches disposed at substantially 90° intervals around the circumference thereof, and further including means which allows for selecting pivoting movement of said arm member between respective open and closed positions of said fastening means.

13. The door unit as claimed in claim 12, wherein said arm member further includes a plurality of knuckles disposed at spaced-apart positions along the lower position thereof, adapted in use to co-operate with complementary knuckles of said roller track, with the interposition of a pivot pin.

14. The door unit as claimed in claim 13, wherein said locking member is an oblong member including a base portion and a substantially cylindrical projection extending substantially normally to said base portion.

15. The door unit as claimed in claim 13, wherein said locking member is a magnetic coupling.

16. An improved bathing enclosure, including one or more door units as claimed in claim 1.

17. A door unit or assembly for an enclosure, said door unit including: a first panel which is adapted to be pivotably movable relative to a wall of said enclosure; a second panel which is adapted to be movably and extensibly connected to said first panel; and a third panel which is pivotably connectable to said second panel, wherein at least one of said panels has a roller track associated with an upper end or extremity thereof and the or each other of said panels has one or more roller brackets associated with an upper end or extremity thereof, the arrangement being such as to allow said panels to be relatively extensible one to the other, and further including means for releasably and selectively retaining said panels in an extended relationship to one another.

18. The door unit as claimed in claim 17, wherein said enclosure is a bathing facility including a bath or tub, wherein said bath or tub includes a rail disposed at the top thereof and extending along the length dimension of the front edge thereof.

19. The door unit as claimed in claim 17, wherein the or each roller bracket includes an adjustment means for positioning rollers relative to said roller track.

20. The door unit as claimed in claim 19, further including roller stop members connected to at least said second panel to thereby limit extension of said second panel relative to said, first panel.

21. The door unit as claimed in claim 20, wherein each panel has associated with the respective top ends or extremities thereof a frame assembly, comprised of an elongate channel member, an end cap assembly and a track which is adapted, in use, to be disposed within said channel member.

22. The door unit as claimed in claim 21, wherein said first panel is adapted, in use, to be pivotably associated with a pivot column assembly which extends substantially along at least a part of the height dimension of said enclosure, said pivot column assembly comprised of a pivot column and a pivot block or bushing at each end of said pivot column, said pivot column assembly being adapted in use to be affixed to a side wall of said enclosure, with or without the interposition of a jamb member.

23. The door unit as claimed in claim 22, wherein said enclosure includes a rail member extending thereacross and releasably affixed thereto.

24. The door unit as claimed in claim 23, including means for releasably retaining said unit in place relative to said rail, thereby to restrict movement of said door unit away from said rail, said retaining means adapted to be activated either internally or externally of said enclosure.

25. The door unit as claimed in claim 24, wherein said retaining means comprises a releasable fastening means which is adapted to be mounted on and to be selectively and progressively movable relative to, the said rail.

26. The door unit as claimed in claim 25, wherein said fastening means includes: a first assembly which is adapted to be disposed externally of said enclosure and which is adapted to co-operate with the rail; and a second assembly which is adapted to be releasably adapted to a second of said panels.

27. The door unit as claimed in claim 26, wherein said first assembly includes a pivotable arm member, a co-operating locking member and a roller track.

28. The door unit as claimed in claim 27, wherein said arm member includes a substantially oblong member having a substantially circular aperture extending therethrough in the vicinity of one end thereof, said aperture including indents or notches disposed at substantially 90° intervals around the circumference thereof, and further including means which allows for selecting pivoting movement of said arm member between respective open and closed positions of said fastening means.

29. The door unit as claimed in claim 28, wherein said arm member further includes a plurality of knuckles disposed at spaced-apart positions along the lower position thereof, adapted in use to co-operate with complementary knuckles of said roller track, with the interposition of a pivot pin.

30. The door unit as claimed in claim 29, wherein said locking member is an oblong member including a base portion and a substantially cylindrical projection extending substantially normally to said base portion.

31. The door unit as claimed in claim 29, wherein said locking member is a magnetic coupling.

32. An improved bathing enclosure, including one or more door units as claimed in claim 17.
